(19) United States
(12) Patent Application Publication
(10) Pub. No.: US 2005/0136276 A1
(43) Pub. Date: Jun. 23, 2005

(54) Synthetic crossband

(75) Inventors: Stephen Borup, Federal Way, WA (US); David G. Gibson, Gig Harbor, WA (US); Robert A. Haupt, Hayward, WI (US); John Spanburg, Thomasville, NC (US)

Correspondence Address: FOLEY & LARDNER, 777 EAST WISCONSIN AVENUE, SUITE 3800, MILWAUKEE, WI, 53202-5308, US

(73) Assignee: Dynea Overlays, Inc.

(21) Appl. No.: 10/744,227

(22) Filed: Dec. 23, 2003

(51) Int. Cl. B32B 21/00

(52) U.S. Cl. 428/528; 162/165; 162/158; 156/307.3; 156/307.7; 428/530

(57) ABSTRACT

A synthetic crossband is disclosed. The synthetic crossband comprises impregnated paper, which is impregnated with a saturating resin which includes phenolic resin, such as phenolic-formaldehyde resin, that is then cured. At least a portion of one side of the impregnated paper includes a layer of partially cured adhesive resin, which includes melamine-formaldehyde resin, urea-formaldehyde resin, or a mixture thereof.

### BACKGROUND

Layered, composite wood structures having an inner core substrate and veneer layers affixed to one or more planer surfaces of the inner core substrate are known in the art. Such composite wood structures exhibit the desirable characteristics of the veneer material while providing a cost savings over a solid structure made entirely of hardwood material. For example, a natural hardwood veneer, such as oak, may be secured to a less expensive substrate, such as high density fiberboard, to produce a composite panel article. The composite wood structures serve a variety of uses, such as floorboards, doors, cabinets, countertops, walls, etc. Veneers used in forming the composite wood structures can be selected from a wide variety of wood materials depending upon economic considerations and the end-use of the structure. Typical woods used as veneers in the past have included ash, birch, cherry, maple, oak, pine, Douglas fir, poplar, mahogany, and walnut.

Wood veneers may be secured to core substrates by lamination processes using resin binders. Conventional adhesive resins may include thermosetting materials existing in aqueous solution, although alcohols or other organics may also be used as solvents. An impregnated crossband can be dried to remove water and/or solvents leaving a dry, solid state resin-reinforced material that may be used as a crossband in the production of laminated constructs. A resin coated crossband may also be used in the production of laminated constructs.

A resin-reinforced crossband may be placed between a veneer sheet and an inner core substrate to form a layered, composite wood material. In commonly employed processes, the layers may be bonded together by introducing a wet spread adhesive between adjacent layers. The resulting multilayer construct may be heated in a compression molding press. The initial heating can cause the adhesive resin to flow into the voids and pores of the core substrate, and the crossband or veneer sheet. With a sufficiently long press cycle, the glue resin polymerizes and irreversibly crosslinks into an intractable network structure (a thermoset) thereby bonding adjacent layers of material. After heating under pressure, the structure is generally cooled after pressing, and thereafter may undergo finishing operations, such as trimming and/or sanding, to form the final product.

An example of a conventional hardwood plywood veneer is shown in FIG. 1. The conventional hardwood plywood veneer includes a top ply of hardwood veneer layer 10 adhered to a core veneer portion 12. The core veneer portion 12 is also adhered to a bottom hardwood veneer layer 10. The conventional hardwood plywood veneer may include a core portion (as shown in FIG. 1) that is itself formed from multiple core layers. One or more of these layers may include an adhesive to bond the core.

Another conventional hardwood plywood construction including phenolic or melamine glue film is shown in FIG. 2. The hardwood laminate includes a top hardwood veneer layer 24. A dry glue film 22 (e.g., a phenolic or melamine dry glue film) is used to adhere the top hardwood veneer 24 to a first side of a core substrate portion 20. The core substrate portion may be made from plywood, particleboard, MDF (medium density fiberboard), or the like. The second side of the core veneer portion 20 is adhered to a bottom hardwood veneer layer 24 with another dry glue film 22.

The production of another conventional crossband-reinforced veneer composite is shown in FIG. 3. The veneer composite includes a hardwood veneer layer 34 which is adhered to a top side of a core panel substrate portion 30 and crossband 32 by introducing wet glue films on the top and bottom of the crossband. The bottom side of the core panel substrate portion 30 may be attached to another crossband 32 and hardwood veneer layer 34. As shown in FIG. 3, the bottom side of the core panel substrate portion 30 is adhered to veneer layer 34 through crossband 32 by introducing wet glue films on the top and bottom of the crossband.

FIG. 4 depicts a schematic of the layers used to form a conventional medium density overlay (MDO) construct. The MDO construct includes two MDO layers 42 and a core plywood portion 40. The two MDO layers 42 each include a dry glue line on the side adjacent to the core plywood portion 40. The MDO layers 42 are adhered to the plywood core portion 40 by placing the sides of the MDO layers 42 having the glue lines in contact with the plywood core portion 40. The typical MDO layers used in forming such constructs consist of a cellulose-fiber sheet impregnated with a thermoset phenolic resin system. The resin-treated material typically does not weigh less than 28 kg/100 m² (174 lbs/3000 ft²) of single face, including both resin and fiber, but exclusive of any glue-line introduced on its surface. After application, the material generally measures no less than about 0.30 mm (0.012 inches) thick.

Despite the numerous alternative materials and arrangements available, there are various problems with conventional layered, wood structures. For example, problems can arise when an uncoated crossband is inserted between a wet glue coated core substrate and an uncoated veneer sheet (e.g., layer). This arrangement can result in areas between the crossband and the veneer sheet that are devoid of adhesive. The use of a medium density overlay (MDO) with a dry glue line/film on one side is generally insufficient to correct this problem due to poor adhesion of the wet spread adhesive to the non-glue line surface of the MDO. The use of wet spread adhesives with uncoated crossbands can cause the unpleasing bleed-through or resin adhesive to the surface of the hardwood veneer. Further, the use of wet spread adhesives in conjunction with the uncoated crossband is often more expensive and more difficult to integrate into the material since it can increase the number of steps required for the production process (and consequently increase the number of overall process steps as well).

Thus, it would be advantageous to provide a synthetic crossband having a layer of partially cured adhesive resin. Further, it would be advantageous to provide a efficient process for making a multi-layer composite material, such as a laminated wood structure, using a synthetic crossband where the layer of non-tacky, partially cured adhesive resin on the crossband is used to bond a hardwood surface veneer. It would be advantageous to provide a system and/or method that includes any one or more of these or other advantageous features.

### SUMMARY

The present invention relates generally to the field of laminated wood products and methods of making the same. Synthetic crossband materials and methods for using the same to produce a multi-layer composite material (e.g., by securing veneers to core substrates) are presented herein.

The synthetic crossband commonly includes a cellulose-fiber sheet (e.g., kraft paper) which is impregnated with a cured saturating resin. Other suitable cellulose fiber sheet materials which can be used to form the present crossband include liner board papers and bleached white papers. The saturating resin commonly includes phenolic resin, such as a phenol-formaldehyde resin, although other conventional saturating resins may be employed. At least a portion of one side of the impregnated paper includes a layer of partially cured adhesive resin. The partially cured adhesive resin commonly includes melamine-formaldehyde resin, urea-formaldehyde resin, or a mixture thereof and is sufficiently cured to provide a non-tacky surface. More desirably, the partially cured adhesive resin is sufficiently cured to provide a dry surface which is “non-blocking,” i.e., a dry surface which will not adhere to a surface of an adjacent material when the synthetic crossband is stored under ambient conditions in stacked or rolled form. The partially cured adhesive resin should, however, be capable of bonding to another surface, e.g., the surface of a hardwood veneer and/or core substrate layer, when exposed to higher temperatures under pressure.

One illustrative embodiment relates to a synthetic crossband. The synthetic crossband comprises impregnated paper which is impregnated with a cured saturating resin. The cured saturating resin commonly includes phenol-formaldehyde resin. At least a portion of one side of the impregnated paper includes a layer of partially cured adhesive resin. The partially cured adhesive resin commonly includes melamine-formaldehyde resin, urea-formaldehyde resin, or a mixture thereof.

Another illustrative embodiment relates to a composite material comprising a wood veneer, such as a hardwood veneer. The wood veneer is bonded to a first side of a crossband layer by a first adhesive layer. The crossband layer comprises paper impregnated with a cured phenolic-formaldehyde resin. The first adhesive layer commonly comprises a melamine-formaldehyde resin, a urea-formaldehyde resin, or a combination thereof.

Another illustrative embodiment relates to a method for making a synthetic crossband. The method comprises impregnating a paper with saturating resin that includes phenolic-formaldehyde resin. The method includes curing the saturating resin in the paper to form a resin reinforced paper. The method includes applying a glue mix to at least a portion of a first side of the resin reinforced paper. The glue mix commonly includes melamine-formaldehyde resin, urea-formaldehyde resin, or a mixture thereof. The method includes partially curing the glue mix.

Another illustrative embodiment relates to a method for making a veneer product. The method comprises contacting a wood veneer with a first side of an impregnated paper to form an uncured construct. The impregnated paper comprises a cured phenol-formaldehyde saturating resin. At least a portion of the side of the first impregnated paper includes a layer of partially cured adhesive resin. The partially cured adhesive resin commonly comprises melamine-formaldehyde resin, urea-formaldehyde resin, or a mixture thereof. The method includes heating the partially cured adhesive resin to bond the impregnated paper to the wood veneer.

Another illustrative embodiment relates to a synthetic crossband made by a process that includes impregnating a paper with a saturating resin. The saturating resin commonly includes phenol-formaldehyde resin. The method includes curing the saturating resin in the paper to form a resin reinforced paper. The method includes applying a glue mix to at least a portion of a first side of the resin reinforced paper. The glue mix commonly includes melamine-formaldehyde resin, urea-formaldehyde resin, or a mixture thereof. The method includes partially curing the glue mix.

Another illustrative embodiment relates to a veneer product made by a process that includes contacting a hardwood veneer with a first side of an impregnated paper to form an uncured construct. The impregnated paper commonly comprises a cured phenolic-formaldehyde saturating resin. At least a portion of the first side of the impregnated paper includes partially cured adhesive resin. The partially cured adhesive resin commonly comprises melamine-formaldehyde resin, urea-formaldehyde resin, or a mixture thereof. The process includes heating the partially cured adhesive resin to bond the impregnated paper to the hardwood veneer.

Another illustrative embodiment relates to a veneer product comprising a core veneer bonded to a first side of an impregnated paper by a first adhesive layer. The impregnated paper is impregnated with a cured saturating resin. The cured saturating resin commonly includes phenol-formaldehyde resin. At least a portion of a second side of the impregnated paper includes a layer of partially cured adhesive resin. The partially cured adhesive resin commonly includes melamine-formaldehyde resin, urea-formaldehyde resin, or a mixture thereof.

### BRIEF DESCRIPTION OF THE DRAWINGS

FIG. 1 is an illustration of a conventional hardwood composite material having a multilayer core substrate portion and outer hardwood veneer layers.

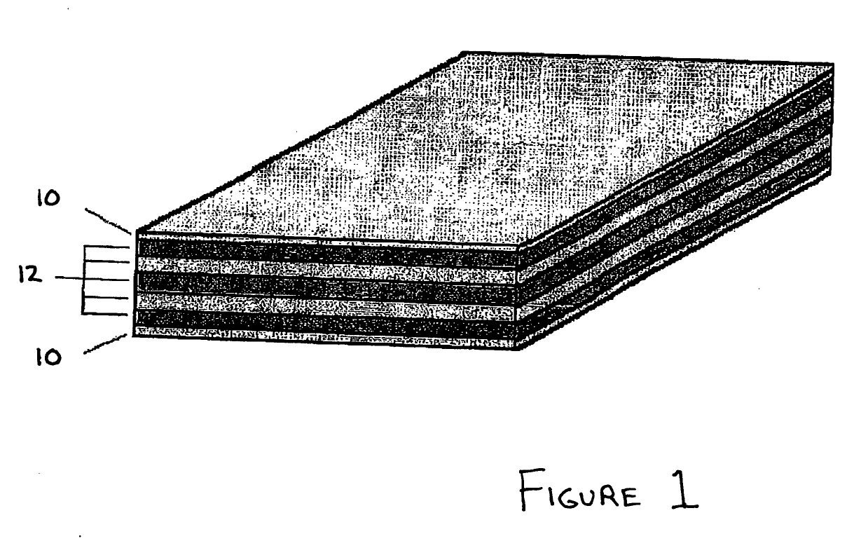

FIG. 2 is a schematic illustration of the layers used to form a conventional composite material, such as the hardwood composite material shown in FIG. 2, which includes having a core substrate portion (e.g., plywood, particle board or MDF) bonded to outer hardwood veneers by dry glue film layers.

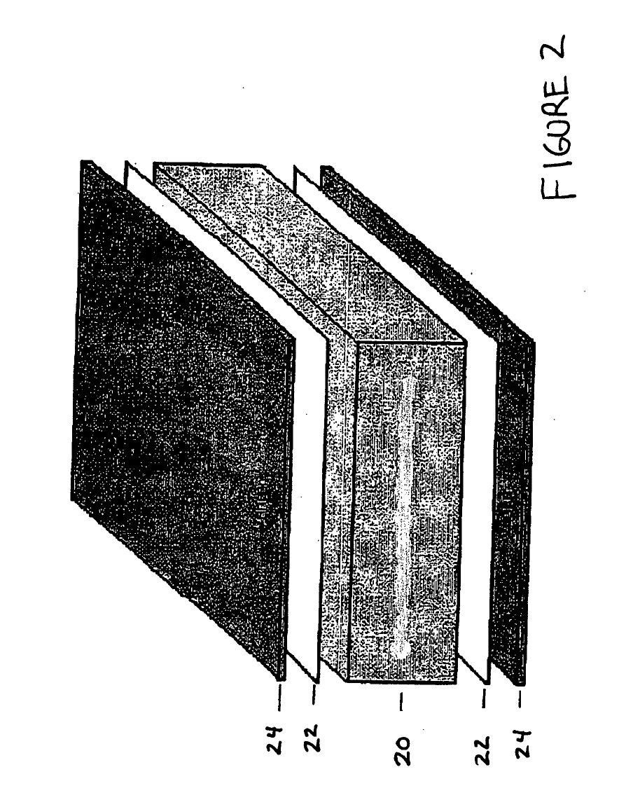

FIG. 3 is a schematic illustration of a the layers of material used to produce a conventional crossband reinforced hardwood veneer composite, where adjacent layers are typically bonded together using wet glue films.

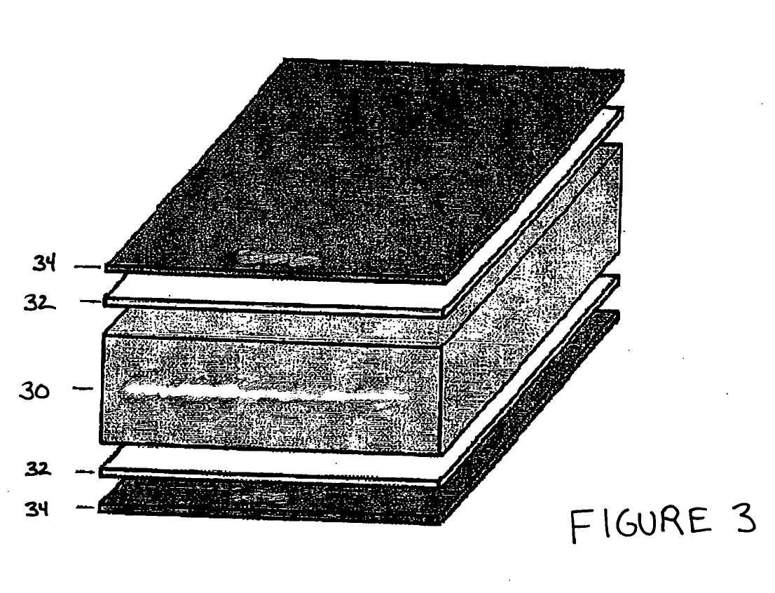

FIG. 4 is a schematic illustration of the layers of material used to produce a conventional medium density overlay.

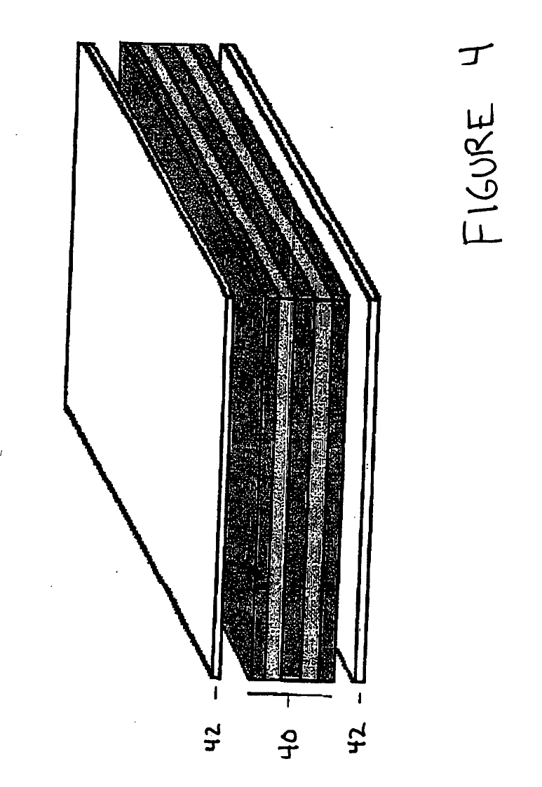

FIG. 5 is a schematic illustration of the synthetic crossband and hardwood veneer layers which can be used to produce a crossband reinforced veneer product according to an exemplary embodiment of the present methods.

FIG. 6 is a schematic illustration of the synthetic crossband, hardwood veneer and core substrate layers which can be used to produce a crossband reinforced veneer product according to another exemplary embodiment of the present methods.

FIG. 7 is an illustration of a crossband reinforced multilayer composite material produced according to an exemplary embodiment of the present methods.

FIG. 8 is a schematic illustration of the layers used to produce a multilayer composite material, such as the hardwood laminated composite material shown in FIG. 7, according to an exemplary embodiment of the present methods.

### DETAILED DESCRIPTION OF VARIOUS EXEMPLARY AND ILLUSTRATIVE EMBODIMENTS

An exemplary synthetic crossband may be formed according to the following process. A roll of paper (e.g., kraft paper having a weight of 132 to 220 lbs/3000 ft²) is placed on an unwind stand. The paper is then threaded through a coater where it is impregnated with resin in a bath. The saturated paper then goes through a pair of rolls where excess resin is removed (e.g., via a squeezing process). The paper is then passed through an oven to cure the resin and dry the paper to predetermined volatile level, e.g. about 2.0 to 2.7 wt. % volatile content. The paper is then passed through another coater which applies an aqueous adhesive resin (“glue mix”) to one side of the paper. The aqueous resin may include urea-formaldehyde resin, melamine-formaldehyde resin, or a mixture thereof. The coated paper is then passed through another oven where the adhesive is partially dried, but not fully cured (i.e., a B stage resin is formed). The paper then passes through chill rolls where it is cooled. The crossband (resin reinforced paper having a dry glue film on one side) may then be either rolled or sheeted for storage at ambient conditions.

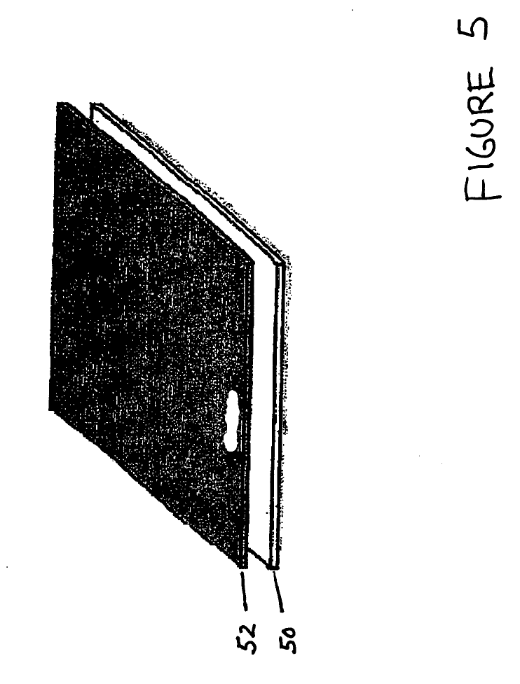

FIG. 5 shows a synthetic crossband material according to an exemplary embodiment. The synthetic crossband material includes a paper 50 impregnated with a cured saturating resin which includes phenolic-formaldehyde resin. At least a portion of one side of the impregnated paper includes a layer of partially cured adhesive resin (e.g., glue mix). The partially cured adhesive resin may include melamine-formaldehyde resin, urea-formaldehyde resin, phenolic-formaldehyde resin, polyvinyl alcohol resin, or a mixture thereof.

For example, synthetic crossband material may be made from paper impregnated with a cured phenolic-formaldehyde resin and having a core volatile content of no more than about 3.0 weight percent. The impregnated paper is commonly no more than about 1/10 of an inch thick and includes at least about 30 weight percent of the cured phenolic-formaldehyde resin. In addition, at least a portion of one side of the impregnated paper includes a B-stage cured adhesive layer (“dry glue line”) which includes a melamine-formaldehyde resin, a urea-formaldehyde resin, or a mixture thereof. As employed herein, the term “B-stage” resin refers to a partially cured thermoset resin which is dry but will flow under the application of heat and pressure. The synthetic crossband material including the impregnated paper and the B-stage cured adhesive layer commonly has a total volatile content of about 3.5 to 4.0 wt. %.

According to an exemplary embodiment, the impregnated paper is formed by impregnating cellulose-fiber sheet material, (e.g., kraft paper) having a weight of about 115 to 225 lbs/3000 ft² with the saturating resin. Desirably, the weight of the paper is about 140 to 175 lbs/3000 ft², and more commonly about 145 to 160 lbs/ft². The paper is impregnated with saturating resin that includes thermoset resin, such as a phenolic-formaldehyde resin. The saturating resin used to impregnate the paper commonly has a viscosity of about 20 to 100 cps, and desirably about 30 to 50 cps. According to an exemplary embodiment, the saturating resin has a non-volatile content of about 40 to 60 wt. %. The saturating resin is then cured in the paper to form a resin reinforced paper, e.g., by heating the impregnated paper to at least about 200° F. After curing, the impregnated paper may include about 25 to 45 wt. % of the cured saturating resin (the amount of cured saturating resin is expressed as a weight percentage of the total dry weight of the resin reinforced paper after removal of volatiles). More commonly, the impregnated paper includes about 30 to 40 wt. % of a cured phenolic-formaldehyde saturating resin. According to an exemplary embodiment, the resin reinforced paper has a volatile content of no more than about 3.0 wt. %. More desirably, the resin reinforced paper has a volatile content of about 1.5 to 3.0 wt. % and, preferably, about 2.0 to 2.7 wt. %.

The adhesive resin (glue mix) may be applied to at least a portion of a first side of the resin reinforced paper in order to form a dry glue line/film. According to various exemplary embodiments, the adhesive resin may be introduced onto the resin reinforced paper in a number of ways prior to being partially cured. For example, the adhesive resin may be applied as a glue mix which may coat the entire surface of the paper, and/or it may be selectively adhered to one or more portions of the paper according to various configurations (e.g., strips, dots, etc.). Alternatively, other suitable methods known to those of skill in the art may be used for placing the adhesive resin on the resin reinforced paper.

The dry glue line may be formed on one side of the resin reinforced paper by applying an appropriate glue mix to at least a portion of a side of the resin reinforced paper. The glue mix generally includes melamine-formaldehyde resin, urea-formaldehyde resin, or a mixture thereof.

According to one exemplary embodiment, sufficient adhesive resin is applied to a portion of the first side of the resin reinforced paper in order to provide a dry glue line/film of about 4 to 7.5 gm/ft² and, more desirably, about 5 to 6.2 gm/ft². According to an exemplary embodiment, the adhesive resin mix used to apply the adhesive may have a viscosity of about 400 to about 1000 cps, desirably about 500 to 800 cps. The adhesive resin may have a non-volatile content of about 45 to 65 wt. %. Melamine-formaldehyde and/or urea-formaldehyde resin glue mixes having non-volatile contents of about 55 to 60 wt. % can be quite suitable.

According to an exemplary embodiment, the adhesive resin is partially cured after being applied to the paper. The adhesive resin is suitably sufficiently cured to provide a non-tacky surface. More desirably, the partially cured adhesive resin is sufficiently cured to provide a dry surface which is “non-blocking,” i.e., a dry surface which will not adhere to a surface of an adjacent material when the synthetic crossband is stored under ambient conditions in stacked or rolled form. This can typically be achieved by curing the adhesive resin to provide a synthetic crossband which has a total volatile content of no more than about 5.0 wt. %. The partially cured adhesive resin should, however, be capable of bonding to another surface, e.g., the surface of a hardwood veneer and/or core substrate layer, when exposed to higher temperatures under pressure. This can commonly be achieved by curing such a melamine-formaldehyde and/or urea-formaldehyde resin glue mix to form a synthetic crossband having a total volatile content of about 3.0 to 5.0 wt. %.

Desirably, the synthetic crossband includes about 4 to 7 gm/ft² of the partially cured adhesive resin. According to an exemplary embodiment, the partially cured adhesive resin is not tacky (e.g., more than one crossband may be rolled or stacked together without adhering to each other). According to another exemplary embodiment, the synthetic crossband, including the resin reinforced paper and the dry glue line, has a total volatile content of about 3.0 to 5.0 wt. %, desirably about 3.5 to 4.5 wt. % and, often about 3.8 to 4.3 wt. %, According to another exemplary embodiment, the synthetic crossband has an internal bonding strength of at least about 100 psi, and desirably at least about 250 psi (as measured by the procedure described in the Illustrative Examples section herein).

According to an exemplary embodiment, the paper used to create the crossband may have the following characteristics. The paper may be kraft paper such as Mead Westvaco 156# MD01 kraft paper with a basis weight of about 148.5 to 154.5 lbs/3000 ft² (at 4% moisture), 5.0% roll average moisture, a wet tensile strength of about 1.7 lbs/in, and a sheet hot extract pH of about 7.0 to 9.0 (Westvaco hot extract method). Desirably, the paper is Mead Westvaco 156# MD01 kraft paper, commercially available from Mead Westvaco). According to other embodiments, any suitable kraft paper, such as Mead Westvaco 132# MD01 kraft paper or Westvaco 220# CF023 kraft paper, may be used. The characteristics of the Mead Westvaco 132# MD01 kraft paper include a basis weight of about 125.5 to 130.5 lbs/3000 ft² (at 4% moisture), 5.0% roll average moisture, an apparent density of about 10.0 to 10.6 mils, and a sheet hot extract pH of about 7.0 to 9.0. The characteristics of the Mead Westvaco 220# CF023 kraft paper include a basis weight of about 209.4 to 217.9 lbs/3000 ft² (at 4% moisture), 5.0% roll average moisture, an apparent density of about 10.0 to 10.6 mils, a wet tensile strength of about 8.5 lbs/in, and a sheet hot extract pH of about 7.0 to 9.0.

According to an exemplary embodiment, the saturating resin may have the following characteristics. The saturating resin may be a phenolic-formaldehyde saturating resin having a refractive index (at about 77 degrees F.) of about 1.4795 to 1.4895, a Brookfield viscosity (at 70 degrees F.) of about 20 to 60 cps, pH of about 7.0 to 7.5, and a nonvolatile percent of about 54.0 to 56.0. One suitable example of the saturating resin is a phenol-formaldehyde resin of the type that is commonly used as an impregnating resin to manufacture MDOs. The resin is suitably ash free and is commonly for use in making paint grade overlays. The resin is neutralized to pH 7.2 with formic acid and has limited water dilutability. The resin is soluble in methanol, ethanol, isopropanol, acetone and sodium hydroxide solutions.

According to an exemplary embodiment, the saturating resin further comprises a defoamer to reduce excess bubbles from forming in the resin mix as it is being used to saturate the paper. For example, petroleum distillates such as those commercially available from Betzdearbom, Inc., may be used as a defoamer in the saturating resin.

According to an exemplary embodiment, the saturating resin further comprises a latex which may be used as an agent to reduce moisture capable of weakening the internal strength of the crossband. The latex may also be used to enhance the ability of the adhesive resin to bond to the paper. For example, an emulsified acrylic copolymer, such as is commercially available from Rohm & Haas, may be used as a latex in the saturating resin.

According to various exemplary embodiments, the saturating resin further comprises a lower alcohol. For example, the saturating resin mix may include a C1-C3 alkanol, such as methanol, ethanol, or isopropyl alcohol (“IPA”). Desirably, methanol may be used as a thinner for the saturating resin (e.g., as about 5 to 15 wt. % of the saturating resin mix) to provide more thorough and faster saturation of the paper.

According to an exemplary embodiment, an aqueous urea-formaldehyde adhesive resin may be used that has the following characteristics. The adhesive resin may have a non-volatile content of about 60.0+/−0.5%, a pH of about 8.2+/−0.2, a Brookfield viscosity of about 600 to 1000 cps, a specific gravity of about 1.250+/−0.010, free formaldehyde of less than about 0.50%, and a storage life of about 6 weeks. For example, the adhesive resin is Dynea CB712 liquid urea formaldehyde resin, commercially available from Dynea Resins, Springfield, Oreg. Dynea CB712 is an aqueous solution of urea formaldehyde resin that is recommended for gluing interior hardwood plywood and furniture parts. It has been specifically formulated to provide exceptional tack and fast bonding speed while retaining excellent dry-out resistance and stability. It is possible to fortify the Dynea CB712 adhesive mix with a melamine formaldehyde resin.

According to another exemplary embodiment, the adhesive resin may further comprise a resin polymerization catalyst, such as a blocked acid catalyst. The acid portion of the catalyst is commonly blocked by an alkaline component that keeps the catalyst neutralized until it is heated. Desirably, the catalyst is one that can be used with both urea-formaldehyde and melamine-formaldehyde resins.

According to an exemplary embodiment, the adhesive resin further comprises a defoamer to reduce excess bubbles from forming in the adhesive resin as it is being used to coat the paper. For example, paraffinic distillate, such as is commercially available from Troy Chemical Corp. may be used as the defoamer for the adhesive resin.

A hardwood veneer composite material may be made according to the following process using the present synthetic crossband. Stacks of veneer are placed in front of a glue spreader and stacks of veneer are placed behind the glue spreader. The veneer located behind the glue spreader is cut perpendicular to the grain and the veneer located in front of the spreader is cut parallel to the grain. Decorative veneer is placed face down and a crossband is placed on top of the veneer so that the dry adhesive resin on the crossband contacts the back of the veneer. The perpendicular veneer is coated with a wet adhesive glue film on both sides and then placed on the crossband. Typical wet adhesive glues used in such applications include phenolic-formaldehyde resins, urea-formaldehyde resins, melamine-formaldehyde resins and/or polyvinyl alcohol resins (“PVAs”). A parallel veneer is then placed on the perpendicular veneer. Another perpendicular veneer (with wet adhesive glue films on both sides) is then placed on the parallel veneer. This process can be continued until the desired height/thickness is obtained (thereby creating a substrate core, center portion, etc.). A crossband is placed on the exposed perpendicular veneer. A decorative veneer is then placed on the crossband in contact with adhesive resin on the crossband. A hot press is used to press the sheets for a given time and pressure at a given temperature sufficient to cure the wet adhesive resin and the dry glue film and bond the layers and hardwood veneer(s) to form a multilayer laminated construct. The panels are taken out of the press, cooled and sanded.

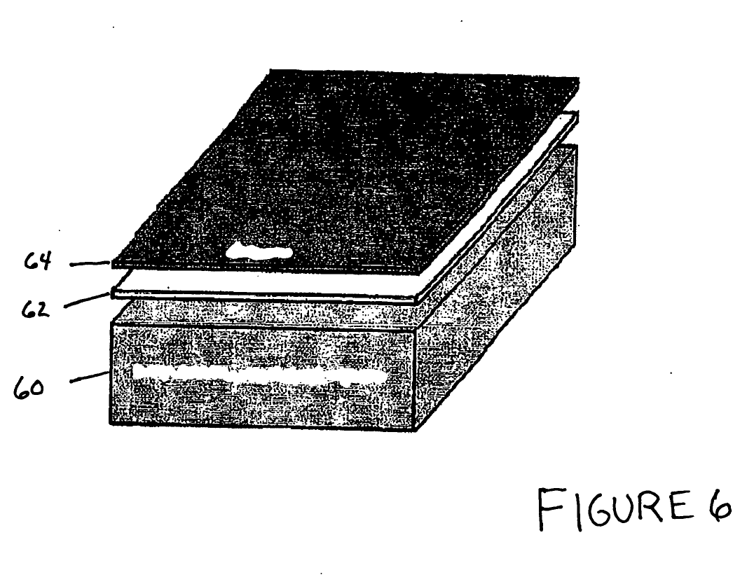

Referring to the exemplary embodiment depicted in FIG. 6, a composite material (e.g., veneer product) is shown comprising a hardwood veneer 64 that may be contacted with an impregnated paper 62 to form an uncured construct. The impregnated paper 62 can include a cured phenolic-formaldehyde saturating resin. At least a portion of one side of the impregnated paper generally includes a layer of partially cured adhesive resin. The partially cured adhesive resin may include melamine-formaldehyde resin, urea-formaldehyde resin, or a mixture thereof. The composite material can be formed by fully curing or heating the partially cured adhesive resin to bond the impregnated paper 62 to the hardwood veneer 64. When the partially cured adhesive resin is heated sufficiently, it is fully cured. Heating is normally accomplished by placing the partially cured adhesive resin in a conventional oven (static or continuous). The uncured material may also be heated by other methods (e.g., the uncured construct can be heated by irradiation, such as with infrared radiation). According to an exemplary embodiment, the partially cured adhesive resin is fully cured by heating the uncured construct to at least about 225 degrees F. Desirably, the partially cured thermoset adhesive resin is fully cured by heating the uncured construct under a pressure of at least about 150 psi. More commonly, curing the partially cured adhesive resin comprises heating the uncured construct to at least about 230 to 270 degrees F. for at least about 5 to 10 minutes under a pressure of about 150 to 200 psi.

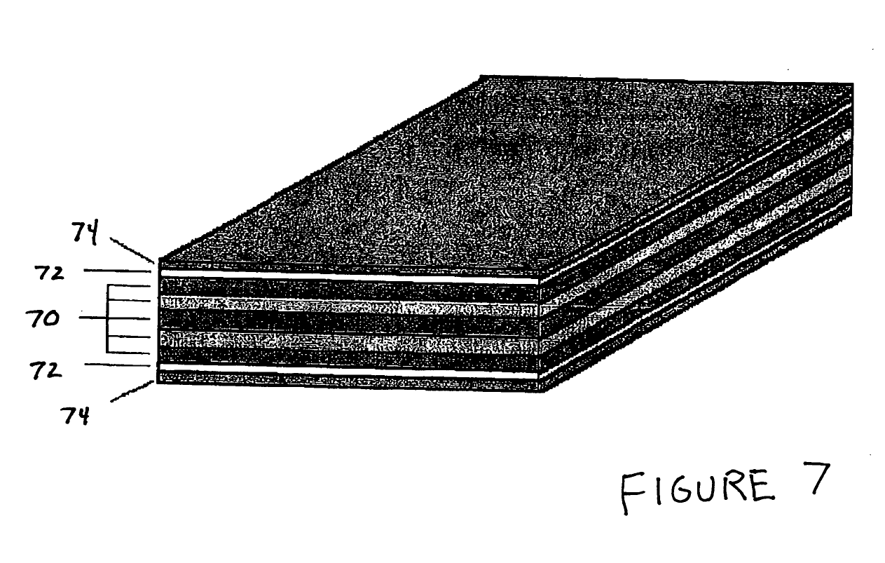

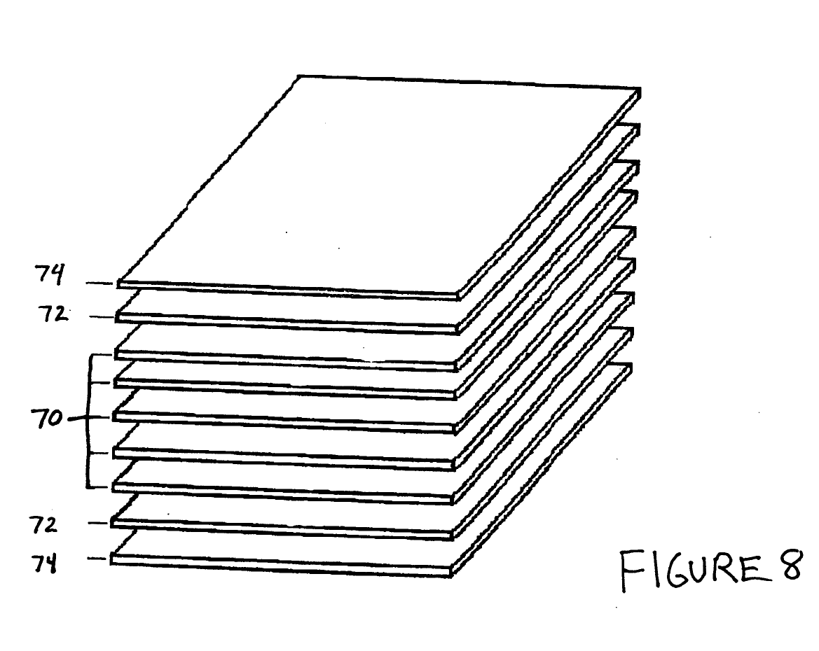

According to an exemplary embodiment, a second side of the impregnated paper 62 may be bonded to a core veneer 60 with a second adhesive layer, e.g., a wet adhesive film. As illustrated in FIGS. 7 and 8, the core veneer itself may be formed from multiple layers wherein contiguous veneer layers are each separated by an uncured wet adhesive layer.

According to an exemplary embodiment, the impregnated paper 62 includes about 25 to 45 wt. % of the cured phenolic-formaldehyde resin, desirably about 30 to 40 wt. % of the cured phenolic-formaldehyde resin, and more commonly about 33 to 35 wt. % of the cured phenolic-formaldehyde resin.

According to various exemplary embodiments, the wood veneer 64 may be a hardwood veneer, such as an ash, birch, cherry, maple, oak, poplar, mahogany, walnut or other hardwood veneer. Softwood veneers, such as pine, Douglas fir, or other softwood veneer may also be used as the wood veneer 64. The wood veneer 64 may have a thickness of about 1/10 to 1/50 of an inch, desirably 1/15 to 1/30 of an inch.

The crossband layer 62 may have a volatile content of no more than about 3.0 wt. % and may have an internal bonding strength of at least about 100 psi, and desirably at least about 250 psi.

In one exemplary embodiment, a plywood or hardwood veneer laminate can be formed from a synthetic crossband (produced according to the general procedure described in Example 1 herein) and a plywood panel or hardwood veneer using the method described in Example 2 herein. For example, the crossband may be formed from Westvaco 156# MD01 kraft paper impregnated with a phenolic-formaldehyde resin (e.g., at about 33-35 wt. % cured resin content) and coated on one side with about 4 to 6 gm/ft² of dry glue line (partially cured to a “B-stage”) which include a melamine-formaldehyde and/or urea-formaldehyde resin.

FIGS. 7 and 8 show a composite material (e.g., hardwood veneer product) comprising hardwood veneer layers 74, crossband layers 72, and a core veneer 70. Unlike the material shown in FIG. 6, core veneer 70 includes multiple core layers and is bonded to a second crossband 72 (which is bonded to a second hardwood veneer 74). Thus, the material shown in FIGS. 7 and 8 can be manufactured as described above with FIG. 6 with the addition of providing multiple layers (bonded together) as a core veneer 70, wherein core veneer 70 is bonded to a second crossband 72 and second veneer 74.

### ILLUSTRATIVE EXAMPLES

The following test methods may be used to determine various characteristics of the materials disclosed herein:

Peel Test of Crossband—Pieces of crossband are placed glue side down on particleboard and then pressed in a hot press at 250° F. for 5 minutes at 175 psi. The materials are then cooled to ambient temperature and the crossband is peeled off. The crossband should be very difficult to remove or it should take a great deal of pull to remove the crossband.

Internal Bond Strength of Crossband—Metal blocks are glued to both sides of 2″×2″ pieces of a synthetic crossband. These metal blocks are put into a testing machine and pulled apart. The internal bonding strength should desirably be at least about 300 psi.

Internal Bond Strength of Panel—The internal bond of a laminated panel is determined by cutting samples into squares, and then putting saw kerfs to a depth of the glue line between the crossband and the first plywood core veneer. The saw kerfs are cut into patterns of 2″×2″ squares in the top of each sample. A steel block is glued to the square area and this assembly is pulled apart. This locates the weakest area of the panel surface and can reveal if there are bonding problems at any of the glue lines.

Peel Test—Hatch marks are cut into the surface of a panel of multilayer composite material. A knife blade is inserted into the cuts and the layer is pried apart. The weak areas are revealed. This will show whether the veneer did not bond to the crossband or whether the crossband did not bond to the core veneer.

The following examples are offered illustratively:

### Example 1

A synthetic crossband may be formed according to the following process. A roll of paper (e.g., Westvaco 156# MD01 kraft paper) is placed on an unwind stand. The paper is then threaded through a coater where it is impregnated with saturating resin in a bath. The saturated paper then goes through a pair of rolls where excess resin is removed (e.g., squeezing process). The paper then goes through an oven to cure the resin and dry the paper to a predetermined volatile level, typically about 2.0 to 2.7 wt. % volatile content. The paper is then passed through another coater which applies an aqueous adhesive resin to one side of the paper. The aqueous resin may include urea-formaldehyde resin, melamine-formaldehyde resin, or a mixture thereof. The coated paper goes through another oven where the adhesive is dried, but not cured. The aqueous adhesive resin is commonly applied at a rate sufficient to form a dry glue film having a wet of about 4 to 7 gm/ft². The paper then passes through chill rolls where it is cooled. The coated crossband is then either rolled or sheeted.

### Example 2

A hardwood composite material may be made according to the following process. Stacks of veneer are placed in front of a glue spreader and stacks of veneer are placed behind the glue spreader. The veneer located behind the glue spreader is cut perpendicular to the grain and the veneer located in front of the spreader is cut parallel to the grain. Decorative veneer is placed face down and a crossband is placed on top of the veneer so that the adhesive resin on the crossband contacts the back of the veneer. The perpendicular veneer is coated with adhesive on both sides and then placed on the crossband. A parallel veneer is then placed on the perpendicular veneer. Another perpendicular veneer (with adhesive on both sides) is then placed on the parallel veneer. This process can be continued until the desired height/thickness is obtained (thereby creating a substrate core, center portion, etc.). A crossband is placed on the exposed perpendicular veneer. A decorative veneer is then placed on the crossband in contact with adhesive resin on the crossband. A hot press is used to press the sheets for a given time and pressure at a given temperature. For example, the sheets can be pressed for about 5 to 6 minutes (for a ¾ inch panel) at about 250 to 260° F. at a pressure of about 175 to 200 psi. The adhesive resin cures and bonds the veneer. The panels are taken out of the press, cooled and sanded.

### Example 3

A melamine-formaldehyde adhesive resin was applied at about 4.5 to 5 gM/ft² to Westvaco 156# kraft paper impregnated with a cured phenolic-formaldehyde resin according to the method described in EXAMPLE 1. The resulting crossband was bonded to a plywood test panel according to the method of EXAMPLE 2 under the following conditions. The sheets were pressed for 1.5, 2.0, 3.0 or 4.0 minutes at about 250° F. under a pressure of about 175 psi. The adhesive resin bonded somewhat at 2.0 minutes, but not at 1.5 minutes. Good bonding was obtained with the panels pressed for 3.0 or 4.0 minutes. Substituting a phenol-formaldehyde adhesive resin (“glue line”) under these conditions did not result in a good bond for any press time at 250° F. from 1.5 minutes to 4.0 minutes. However, the phenol-formaldehyde adhesive resin did bond well at 285° F. with press times of 2.5, 3.0, and 4.0 minutes.

### Example 4

According to an exemplary embodiment, Westvaco 156# MD01 kraft paper was treated with a saturating resin mix which included phenol-formaldehyde resin and a solution of polyvinyl butyral. After curing, the treated paper had a 33% resin content and 2% volatile content. A melamine-formaldehyde glue line was applied to the paper at about 5 gm/ft² and cured to a B-stage.

The treated paper was pressed against a core veneer and the glue line transferred to the core veneer, but did not bond to the paper. Lowering the resin content to 28 wt. % and raising the volatile content to 4 wt. % did not appear to improve the bonding.

The same melamine-formaldehyde glue line when applied to an impregnated paper (formed from Westvaco 132# kraft paper impregnated with a saturating resin which includes phenol-formaldehyde resin) bonded well with the core veneer.

### Example 5

According to an exemplary embodiment, Westvaco 156# MD01 kraft paper can be treated with a saturating resin mix which includes phenol-formaldehyde resin, fatty acid and latex. After curing the resin content of the impregnated paper is 33 wt. %. A melamine-formaldehyde resin glue line can be applied to one side to provide a weight of 5 gm/ft² after partial curing to a B-stage. The crossband is placed on a plywood panel using a urea-formaldehyde wet adhesive. The B-stage melamine-formaldehyde resin is placed against an oak veneer and bonds well to the veneer at press cycles as low as 90 seconds at 250° F.

Internal bonding tests may show some weakness in the paper. The crossband itself had an internal bond strength just under that of the plywood (e.g., about 100-150 psi where 200 psi is a target).

### Example 6

Westvaco 156# MD01 kraft paper can be treated with a saturating resin mix which includes phenol-formaldehyde resin and latex. This saturating resin mix is selected to eliminate fatty acid. The paper is processed at a line speed of about 170 ft/min. The paper is fully cured in an oven (core volatile content of no more than about 2.5 wt. %) and then a melamine-formaldehyde glue line is applied. The final product has a resin content of about 33.5 wt. %, a total volatile content of about 3.7 wt. %, and a glue line weight of about 4.6 gm/ft² (cured to a B-stage).

This process results in a melamine-formaldehyde glue line that can bond well at conventional hardwood plywood press temperatures and cycles. The internal strength of the crossband is stronger than the veneer substrate. The surface of the crossband accepts liquid adhesives well and bonds well to the substrate.

### Example 7

Westvaco 156# MD01 kraft paper can be impregnated with a saturating resin mix which includes phenol-formaldehyde resin and latex and fully cured. A partially cured melamine-formaldehyde resin is then applied to a portion of one side of the paper at about 4.5 to 5 gm/ft² (thereby creating a crossband). A veneer layer is then placed in contact with the partially cured melamine-formaldehyde resin on the paper. The resulting construct can be bonded under the following pressing conditions: (1) hot press at 265° F.; (2) press time—5.5 minutes; (3) pressure of 175 psi on commercial production line.

Peel tests showed that the face veneer is able to be peeled away at the melamine resin. The resin seemed to transfer to the veneer, but does not stick to the crossband. The bond seemed to improve somewhat after cooling, but still does not appear to produce a consistent bond. The veneer could be peeled off after pressing at both high and low press temperatures (250 to 300° F.) and short and long press cycles (5 to 10 minutes).

Westvaco 132# MD01 kraft paper can be impregnated with a saturating resin mix, which includes phenolic-formaldehyde resin and latex, and fully cured. A melamine-formaldehyde and/or urea-formaldehyde resin may then be applied to a portion of one side of the paper at about 4.5 to 5 gm/ft² (thereby creating a crossband). A veneer layer can then be placed in contact with the partially cured melamine-formaldehyde resin on the paper. The resulting construct can be bonded under conventional pressing conditions, e.g., (1) hot press at 265° F.; (2) press time—5.5 minutes; (3) pressure of 175 psi.

Peel tests showed that the face veneer was not able to be peeled away at the melamine resin. The impregnated Westvaco 132# MD01 kraft paper has a lower basis weight than the Westvaco 156# MD01 kraft paper and has 6% less saturating resin.

### Example 8

Westvaco 156# MD01 kraft paper was impregnated with a saturating resin mix which includes phenol-formaldehyde resin and fully cured. A melamine-formaldehyde resin was applied to a portion of one side of the paper and partially cured (thereby creating a crossband having a dry glue line with about 4.5 to 5 gm/ft² of a dry MF glue line on one side). A veneer layer was then placed in contact with the partially cured melamine-formaldehyde resin on the paper.

The resin contents ranged from 30 to 36%. Volatile contents ranged from about 1.8 to 2.4 wt. %. The internal bond strengths (“IBs”) of the resulting resin reinforced paper were 125 to 210 psi. The higher IBs were observed for the resin reinforced papers having the lower volatile contents. A mahogany veneer face was placed on top of the partially cured melamine-formaldehyde resin (on the crossband) and pressed at 250° F. for 6 minutes.

Under this arrangement, it is possible for moisture from urea-formaldehyde resin to weaken the center of the crossband. In order to correct this problem, samples of the crossband were placed in a 360° F. oven for 60 seconds to attempt to completely cure the phenolic-formaldehyde resin. This process resulted in an internal bonding strength increase of about 22%. After placing the crossband in the oven for 60 seconds, the water absorption was reduced an average of 55%.

Another set of conditions were also conducted. Phenolic-formaldehyde resin was used to impregnate the paper. The paper was cured at 160° F. and volatile content was between 0.8% and 1.6%. A cure indicator showed all but the 1.6% volatile sample was completely cured. Internal bonding was in the 340 psi range. Water absorption averaged about 14% except for the 1.6% volatile content sample which was 32%.

A melamine-formaldehyde (MF) resin was applied and plywood panels were placed on the paper (creating an MF crossband material). The melamine-formaldehyde resin generally bonded well and the center of the crossband remained strong. A urea-formaldehyde (UF) resin was applied to the resin reinforced paper and partially cured to a B-stage (creating a “UF crossband”). The UF resin bonded to a veneer better than the MF resin bonded to a veneer. Hot peel tests showed complete bonding with the UF resin and somewhat poorer bonding and resin transfer away from the crossband with the MF resin.

Peel tests comparing the MF resin to the UF resin at lower temperatures and press times showed the MF resin bond needed about 3 minutes at 250° F. while the UF resin bond could be bonded after pressing for about 1.5 minutes at 240° F.

### Example 9

Westvaco 156# MD01 kraft paper can be impregnated with a saturating resin mix which includes phenol-formaldehyde resin and fully cured. A urea-formaldehyde resin was applied to a portion of one side of the paper (thereby creating a crossband) and partially cured. A veneer layer was then placed in contact with the partially cured urea-formaldehyde resin (“dry glue line”) on the paper.

Two core volatile content conditions were run: (1) 1.8% and (2) 2.5%. Further, two urea-formaldehyde resin applications were run: (1) 4.5 gm/ft² and 5.5 gm/ft². The glue line resin bonds well to oak, maple and birch veneer at relatively short cycles (e.g., 4 minutes at 250° F.). The internal bonding strength of the resin reinforced paper was high (e.g., about 530 to 640 psi).

Directly out of the press, the veneer could not be peeled off of the board in most cases. The oak veneer and the birch veneer appeared to bond well under all conditions tested. The maple veneer needed higher temperatures and press cycles.

Internal bonding of the pressed panels showed some weakness in the bond between the overlay and the substrate.

### Example 10

A synthetic crossband may be formed according to the following process. A roll of paper (e.g., Westvaco 156# MD01 kraft paper) is placed on an unwind stand. The paper is then threaded through a coater where it is impregnated with saturating resin mix in a bath. The saturating resin mix consists of 85.16 wt. % phenolic-formaldehyde resin, 0.04 wt. % petroleum distillate defoamer, 1.81 wt. % latex, 9.75 wt. % methanol and 3.25 wt. % water. The phenolic-formaldehyde saturating resin may have a refractive index (at about 77 degrees F.) of about 1.4795 to 1.4895, a Brookfield viscosity (at 70 degrees F.) of about 20 to 60 cps, pH of about 7.0 to 7.5, and a nonvolatile percent of about 54.0 to 56.0. One suitable example of the saturating resin is a phenol-formaldehyde resin of the type that is commonly used as an impregnating resin to manufacture MDOs. The resin is suitably ash free and is commonly for use in making paint grade overlays. The resin is neutralized to pH 7.2 with formic acid and has limited water dilutability. The resin is soluble in methanol, ethanol, isopropanol, acetone and sodium hydroxide solutions.

The saturated paper is then passed through a pair of rolls where excess resin is removed (e.g., via a squeezing process). The saturated paper then passes through an oven at about 400-490° F. to cure the resin and dry the paper to predetermined volatile level, typically about 2.0 to 2.7 wt. % volatile content. The saturating resin mix has a Brookfield viscosity (at 70° F.) of about 50-90 cps, a pH of about 8.6-9.15 and a % NV of about 48 wt. %. The resulting resin reinforced paper has a resin content of about 34 wt. %.

The paper is then passed through another coater which applies an aqueous glue mix to one side of the paper. The aqueous resin may include urea-formaldehyde resin, melamine-formaldehyde resin, or a mixture thereof. For example the aqueous glue mix can include 82.47 wt. % (including solvent) urea-formaldehyde resin, 0.58 wt. % defoamer, 6.17% glufil, 1.50 wt. % CT230C resin catalyst, and 9.28 wt. % water. Such an aqueous glue mix typically has a Brookfield viscosity (at 70° F.) of about 500-700 cps and a % NV of about 58 wt. %. The resin reinforced paper coated with the glue mix is through passed another oven at about 210 to 230° F. where the adhesive is dried, but not cured (typically to a total volatile content of about 3.8-4.3 wt. %). The aqueous adhesive resin is commonly applied at a rate sufficient to form a dry glue film having a wet of about 5 to 6.2 gm/ft². The paper then passes through chill rolls where it is cooled. The coated crossband is then either rolled or sheeted.

### Example 11

A hardwood composite material may be made from the synthetic crossband described in Example 13 according to the following process. Stacks of veneer are placed in front of a glue spreader and stacks of veneer are placed behind the glue spreader. The veneer located behind the glue spreader is cut perpendicular to the grain and the veneer located in front of the spreader is cut parallel to the grain. Decorative veneer is placed face down and a crossband is placed on top of the veneer so that the dry adhesive resin on the crossband contacts the back of the veneer. The perpendicular veneer is coated with a wet adhesive film on both sides and then placed on the crossband. A parallel veneer is then placed on the perpendicular veneer. Another perpendicular veneer (with wet adhesive on both sides) is then placed on the parallel veneer. This process can be continued until the desired height/thickness is obtained (thereby creating an uncured construct which includes a hardwood veneer, synthetic crossband, and multiple layer for forming a central substrate core). A crossband may be placed on the exposed uppermost perpendicular veneer. A decorative hardwood veneer can then be placed on the crossband in contact with adhesive resin on the crossband. A hot press is used to press the sheets for a given time and pressure at a given temperature, e.g., for about 5 to 10 minutes at about 230 to 270° F. under a pressure of about 150 to 200 psi. During this operation the dry adhesive resin cures and bonds the hardwood veneer(s) to the crossband(s). The wet glue films also cure to bond adjacent layers of the construct. The resulting multilayer veneer panels are taken out of the press, cooled and sanded.

### Example 12

A veneer product can be made according to the following process. A core veneer may be bonded to a first side of an impregnated paper by curing (e.g., heating) a first adhesive layer to form a first construct. The impregnated paper can be impregnated with a cured saturating resin which may include phenolic-formaldehyde resin. A second adhesive layer may then be applied to a second side of the impregnated paper. The second adhesive layer may include melamine-formaldehyde resin, urea-formaldehyde resin, or a mixture thereof. The second adhesive layer is then at least partially cured (e.g., by heating the second adhesive) to form a partially cured adhesive layer on the second side of the impregnated paper. The resulting construct includes a substrate layer (e.g., a core veneer) bonded to a first side of the impregnated paper and the partially cured adhesive layer on the second side of the impregnated paper.

A hardwood veneer may then be contacted with the second side of the impregnated paper. The hardwood veneer is then bonded to the impregnated paper by curing (e.g., heating) the glue mix.

It is important to note that the method and systems described in the exemplary embodiments herein are provided for illustrative purposes only. Although only a few embodiments of the present inventions have been described in detail in this disclosure, those skilled in the art who review this disclosure will readily appreciate that many modifications are possible (e.g., variations in values of parameters, etc.) without materially departing from the novel teachings and advantages of the subject matter recited herein. Other substitutions, modifications, changes and omissions may be made in the design, operating conditions and arrangement of the preferred and other exemplary embodiments without departing from the scope of the present inventions.

1. A synthetic crossband comprising
impregnated paper which is impregnated with a cured saturating resin which includes phenolic resin;
wherein at least a portion of one side of the impregnated paper includes a layer of partially cured adhesive resin, which includes melamine-formaldehyde resin, urea-formaldehyde resin, or a mixture thereof.

2. The synthetic crossband of claim 1, wherein the impregnated paper is formed by impregnating a paper having a weight of about 115 to 225 lbs/3000 ft² with the saturating resin.

3. The synthetic crossband of claim 1, wherein the impregnated paper is formed by impregnating a kraft paper with the saturating resin.

4. The synthetic crossband of claim 1, wherein the impregnated paper has a volatile content of no more than about 3.0 wt. %.

5. The synthetic crossband of claim 1, wherein the synthetic crossband includes about 4 to 7 gm/ft² of the partially cured adhesive resin.

6. The synthetic crossband of claim 1, wherein the adhesive resin comprises the urea-formaldehyde resin.

7. The synthetic crossband of claim 1, wherein the adhesive resin comprises the melamine-formaldehyde resin.

8. The synthetic crossband of claim 1, wherein the phenolic resin comprises phenol-formaldehyde resin.

9. The synthetic crossband of claim 1, wherein synthetic crossband has a total volatile content of about 3.0 to 5.0%.

10. The synthetic crossband of claim 1, wherein the impregnated paper includes about 25 to 45 wt % of the cured phenolic-formaldehyde resin.

11. The method of claim 1, wherein synthetic crossband has an internal bonding strength of at least about 100 psi.

12. A composite material comprising:
a wood veneer bonded to a first side of a crossband layer by a first adhesive layer;
wherein the crossband layer comprises paper impregnated with a cured phenolic resin; and the first adhesive layer comprises a melamine-formaldehyde resin, a urea-formaldehyde resin, or a combination thereof.

13. The material of claim 12, wherein the impregnated paper includes about 25 to 45 wt % of a cured phenol-formaldehyde resin.

14. The material of claim 12, further comprising a core veneer bonded to a second side of the crossband layer by a second adhesive layer.

15. The material of claim 12, wherein the core veneer is a multi-layer composite material.

16. The material of claim 12, wherein the crossband layer has a volatile content of no more than about 3.0 wt. %.

17. The material of claim 12, wherein the wood veneer is a hardwood veneer.

18. The material of claim 17, wherein the hardwood veneer is an ash, birch, cherry, maple, oak, poplar, mahogany, or walnut veneer.

19. The material of claim 12, wherein the wood veneer is a softwood veneer.

20. The material of claim 19, wherein the softwood veneer is a Douglas fir or pine veneer.

21. The material of claim 12, wherein the hardwood veneer has a thickness of about 1/10 to 1/50 of an inch.

22. The method of claim 12, wherein the crossband layer has an internal bonding strength of at least about 100 psi.

23. A method for making a synthetic crossband, comprising:
impregnating a paper with saturating resin that includes phenolic resin;
curing the saturating resin in the paper to form a resin reinforced paper;
applying a glue mix to at least a portion of a first side of the resin reinforced paper, wherein the glue mix includes melamine-formaldehyde resin, urea-formaldehyde resin, or a mixture thereof; and
partially curing the glue mix.

24. The method of claim 23, wherein curing the saturating resin comprises heating the impregnated paper to at least about 200° F.

25. The method of claim 23, wherein the glue mix includes melamine-formaldehyde resin.

26. The method of claim 23, wherein the glue mix includes urea-formaldehyde resin.

27. The method of claim 23, comprising applying about 4 to 6 gm/ft² of the glue mix to the portion of the first side of the resin reinforced paper.

28. The method of claim 23, wherein the saturating resin further comprises a defoamer.

29. The method of claim 23, wherein the saturating resin further comprises a latex.

30. The method of claim 23, wherein the saturating resin further comprises lower alcohol.

31. The method of claim 23, wherein the saturating resin has a viscosity of about 20 to 100 cps.

32. The method of claim 23, wherein the saturating resin has a non-volatile content of about 40 to 60 wt. %.

33. The method of claim 23, wherein the glue mix further comprises a defoamer.

34. The method of claim 23, wherein the glue mix has a viscosity of about 400 to 1000 cps.

35. The method of claim 23, wherein the glue mix has a non-volatile content of about 45 to 65 wt. %.

36. The method of claim 23, wherein the glue mix further comprises a resin polymerization catalyst.

37. A method for making a veneer product, comprising:
contacting a wood veneer with a first side of an impregnated paper to form an uncured construct, wherein the impregnated paper comprises a cured phenolic resin and at least a portion of the first side of the impregnated paper includes a layer of partially cured adhesive resin, which comprises melamine-formaldehyde resin, urea-formaldehyde resin, or a mixture thereof; and
heating the partially cured adhesive resin to bond the impregnated paper to the wood veneer.

38. The method of claim 37, further comprising bonding a second side of the impregnated paper to a core veneer with a second adhesive layer.

39. The method of claim 38, wherein the core veneer comprises more than one veneer layer and contiguous veneer layers are each separated by an uncured wet adhesive layer.

40. The method of claim 37, wherein fully curing the partially cured adhesive resin comprises heating the uncured construct to at least about 225° F. under pressure.

41. The method of claim 37, wherein curing the partially cured adhesive resin comprises heating the uncured construct under a pressure of at least about 150 psi.

42. The method of claim 37, wherein curing the partially cured adhesive resin comprises heating the uncured construct to at least about 230 to 270 degrees F. for at least about 5 to 10 minutes under a pressure of about 150 to 200 psi.

43. A synthetic crossband made by a process that includes:
impregnating a paper with a saturating resin that includes phenolic resin;
curing the saturating resin in the paper to form a resin reinforced paper;
applying a glue mix to at least a portion of a first side of the resin reinforced paper, wherein the glue mix includes melamine-formaldehyde resin, urea-formaldehyde resin, or a mixture thereof; and
partially curing the glue mix.

44. A veneer product made by a process that includes:
contacting a wood veneer with a first side of an impregnated paper to form an uncured construct, wherein the impregnated paper comprises a cured phenolic resin and at least a portion of the first side of the impregnated paper includes partially cured adhesive resin, which comprises melamine-formaldehyde resin, urea-formaldehyde resin, or a mixture thereof; and
heating the partially cured adhesive resin to bond the impregnated paper to the wood veneer.

45. A veneer product comprising:
a core veneer bonded to a first side of an impregnated paper by a first adhesive layer;
wherein the impregnated paper is impregnated with a cured saturating resin which includes phenolic resin; and at least a portion of a second side of the impregnated paper includes a layer of partially cured adhesive resin, which includes melamine-formaldehyde resin, urea-formaldehyde resin, or a mixture thereof.
